(19) United States
(12) Patent Application Publication
(10) Pub. No.: US 2008/0231185 A1
(43) Pub. Date: Sep. 25, 2008

(54) ELECTRODE SHEET FOR PLASMA DISPLAY PANEL AND PLASMA DISPLAY PANEL USING THE SAME

(76) Inventors: Tae-seung Cho, Suwon (KR); Young-do Choi, Suwon (KR); Jae-ik Kwon, Suwon (KR)

Correspondence Address: CHRISTIE, PARKER & HALE, LLP, PO BOX 7068, PASADENA, CA, 91109-7068, US

(21) Appl. No.: 12/051,764

(22) Filed: Mar. 19, 2008

(30) Foreign Application Priority Data
Mar. 22, 2007 (KR) 10-2007-0028165

(51) Int. Cl. H01J 17/49; H01J 9/00

(52) U.S. Cl. 313/582; 445/22

(57) ABSTRACT

An electrode sheet for a plasma display panel including a conductive discharge unit and a dielectric layer, the conductive discharge unit being covered (or encapsulated or buried) by the dielectric layer, and a plasma display panel using the same. The electrode sheet according to an embodiment of the present invention may be economically and easily manufactured using a metal anodizing process.

### CROSS-REFERENCE TO RELATED APPLICATIONS

This application claims priority to and the benefit of Korean Patent Application No. 10-2007-0028165, filed on Mar. 22, 2007, in the Korean Intellectual Property Office, the entire content of which is incorporated herein by reference.

### BACKGROUND

1. Field of the Invention

The present invention relates to a plasma display panel, and more particularly, to an electrode configuration of a plasma display.

2. Discussion of Related Art

A plasma display panel can be categorized as a DC plasma display panel, an AC plasma display panel or a hybrid plasma display panel, depending on the applied discharge voltage. In addition, a plasma display panel can be categorized as an opposed discharge plasma display panel or a surface discharge plasma display panel, depending on how its electric charges are discharged (i.e., according to the configuration of its electrodes for discharging the electric charges).

The DC plasma display panel has a structure in which all electrodes are exposed to a discharge space, and electric charges are directly transferred between the corresponding electrodes. The AC plasma display panel has at least one electrode surrounded with a dielectric layer, wherein electric charges are not directly transferred between the corresponding electrodes and a discharge is achieved by utilizing a wall charge field.

In the case of the DC plasma display panel, the electrodes can be severely damaged because the electric charges are directly transferred between the corresponding electrodes. Therefore, the AC plasma display panel has been used more widely in recent years.

In the case of the AC plasma display panel, a three-electrode surface discharge plasma display panel has been developed. The three-electrode surface discharge plasma display panel has a structure surrounding a discharge space defined by a front glass substrate, a rear glass substrate and a barrier rib, and the structure surrounding the discharge space has an address electrode, an X electrode and a Y electrode arranged therein.

However, during an address discharge, the AC plasma display panel has a problem in that an address discharge voltage is relatively high and slow to be sustained because a discharge route (or path) between the address electrode and the X electrode or Y electrode is relatively long.

### SUMMARY OF THE INVENTION

Aspects of embodiments of the present invention are directed toward an electrode sheet for a plasma display panel having an AC electrode structure capable of preventing (or reducing) an erroneous discharge that may be caused by a factor external to the discharge cells, and a plasma display panel having the same.

An embodiment of the present invention provides an electrode sheet for a plasma display panel. The electrode sheet includes a dielectric layer having a first surface and a second surface and including a plurality of discharge holes defined by side walls of discharge spaces, the dielectric layer being composed of a metal oxide; and a discharge electrode including a plurality of discharge units around circumferences of the discharge holes and a connection unit for connecting the discharge units to each other, the discharge electrode being embedded inside the dielectric layer, the discharge electrode being composed of a metal of the metal oxide. Here, the discharge units of the discharge electrode are embedded inside the dielectric layer so that a distance between the discharge units and the first surface is different from a distance between the discharge units and the second surface.

Another embodiment of the present invention provides a plasma display panel including a first glass substrate; a second glass substrate facing the first glass substrate and arranged with the first glass substrate with a gap therebetween; a first dielectric layer arranged between the first glass substrate and the second glass substrate and including a plurality of first discharge holes defined by side walls of discharge spaces, the first dielectric layer being composed of a metal oxide; a first electrode sheet embedded inside the first dielectric layer and including a plurality of first discharge units around circumferences of the first discharge holes and a first connection unit for connecting the first discharge units to each other, the first electrode sheet including a first discharge electrode composed of a metal of the metal oxide; a second dielectric layer arranged between the first electrode sheet and the second glass substrate and including a plurality of second discharge holes arranged to correspond to the first discharge holes and defined by the side walls of the discharge spaces; and a second electrode sheet embedded inside the second dielectric layer and including a plurality of second discharge units around circumferences of the second discharge holes and a second connection unit for connecting the second discharge units to each other, the second electrode sheet including a second discharge electrode composed of a metal of the metal oxide. Here, the first discharge units of the first discharge electrode are embedded inside the first dielectric layer so that a distance between the first discharge units and a surface where the first dielectric layer is in contact with the first glass substrate is smaller than a distance between the first discharge units and a surface where the first dielectric layer is in contact with the second dielectric layer, and the second discharge units of the second discharge electrode are embedded inside the second dielectric layer so that a distance between the second discharge units and a surface where the second dielectric layer is in contact with the first dielectric layer is larger than a distance between the second discharge units and a surface where the second dielectric layer is in contact with the second glass substrate.

Another embodiment of the present invention provides a method for manufacturing an electrode sheet for a plasma display panel in which a discharge electrode is embedded, the discharge electrode including a plurality of discharge units around circumferences of a plurality of discharge holes and a connection unit for connecting the discharge units to each other, and the discharge units are formed so that a distance from the discharge units to one surface of the dielectric layer is different from a distance from the discharge unit to another surface of the dielectric layer. The method includes providing a metal sheet; forming a plurality of discharge holes on the metal sheet; attaching a first protective film for forming a pattern of a discharge electrode to a first surface of the metal sheet; anodizing a region of the metal sheet where the first protective film is not attached to a first depth measured from a second surface of the metal sheet; detaching the first protective film; and anodizing the metal sheet to a second depth measure from the first surface of the metal sheet to form the discharge electrode, wherein the second depth is different from the first depth.

If the electrode sheet for a plasma display panel according to an embodiment of the present invention is used herein, the structure of the plasma display device may be simplified, and the VUV emission may be increased due to a long gap effect by extending a distance between discharge units. Also, an invalid power consumption may be lowered due to a lower electrostatic capacity of the plasma display panel.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view showing a plasma display panel according to an embodiment of the present invention.

FIG. 2A is a perspective view showing one embodiment of a first electrode sheet as shown in FIG. 1.

FIG. 2B is an enlarged view showing a circumferential region of a unit discharge hole in the first electrode sheet as shown in FIG. 2A.

FIG. 2C is a cross-sectional view taken along a line A-A′ as shown in FIG. 2B.

FIG. 2D is a cross-sectional view taken along a line B-B′ as shown in FIG. 2B.

FIG. 3A is a perspective view showing one embodiment of a second electrode sheet as shown in FIG. 1.

FIG. 3B is an enlarged view showing a circumferential region of a unit discharge hole in the second electrode sheet as shown in FIG. 3A.

FIG. 3C is a cross-sectional view taken along a line A-A′ as shown in FIG. 3B.

FIG. 3D is a cross-sectional view taken along a line B-B′ as shown in FIG. 3B.

FIG. 4 is a cross-sectional view showing a laminated structure of the first electrode sheet and the second electrode sheet as shown in FIGS. 2A to 2D and FIGS. 3A to 3D.

FIG. 5 is a cross-sectional view showing a laminated structure of the first electrode sheet and the second electrode sheet according to another embodiment of the present invention.

FIGS. 6A, 6B, 6C, 6D, 6E, and 6F are cross-sectional views illustrating a process for manufacturing a plasma display panel according to an embodiment of the present invention.

### DETAILED DESCRIPTION

Hereinafter, exemplary embodiments according to the present invention will be described with reference to the accompanying drawings. Here, when one element is described as being connected to another element, one element may be not only directly connected to another element but instead may be indirectly connected to another element via one or more other elements. Also, in the context of the present application, when an element is referred to as being “on” another element, it can be directly on the another element or be indirectly on the another element with one or more intervening elements interposed therebetween. Further, some of the elements that are not essential to the complete description of the invention have been omitted for clarity. Also, like reference numerals refer to like elements throughout.

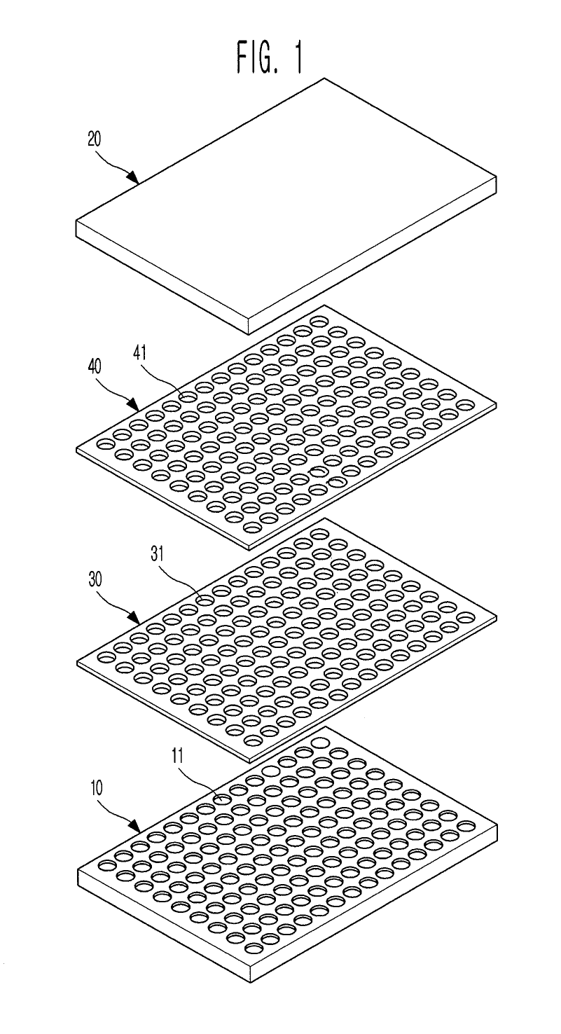

FIG. 1 is an exploded perspective view showing a plasma display panel according to an embodiment of the present invention.

Referring to FIG. 1, the plasma display panel includes a rear glass substrate 10, a front glass substrate 20, a first electrode sheet 30, and a second electrode sheet 40.

The rear glass substrate 10 and the front glass substrate 20 are arranged with each other with a gap (or a substantially constant gap) therebetween, and the first electrode sheet 30 and the second electrode sheet 40 are provided between the rear glass substrate 10 and the front glass substrate 20. The first electrode sheet 30 is an electrode sheet formed at (or on) the rear glass substrate 10, and the second electrode sheet 40 is an electrode sheet formed at (or on) the front glass substrate 20.

A plurality of first discharge holes 31 and a plurality of second discharge holes 41 are formed in the first electrode sheet 30 and the second electrode sheet 40, respectively. The first discharge holes 31 and the second discharge holes 41 face or correspond to each other. Accordingly, in this embodiment, discharge spaces are defined by the rear glass substrate 10 formed as a bottom surface, the front glass substrate 20 formed as a top surface, and the discharge holes 31, 41 formed as inner wall surfaces, and each of the discharge spaces includes a discharge gas formed therein. In addition, a phosphor layer is provided in a groove 11 (or each of the grooves 11) formed by etching the rear glass substrate 10 to a certain (or predetermined) depth.

In the case of the plasma display panel as configured above, a discharge between a first discharge electrode provided inside the first electrode sheet 30 and a second discharge electrode provided in the second electrode sheet 40 is carried out from (or implemented by) an external power source to drive the plasma display panel.

For example, if power(s) of the power source are applied to the first discharge electrode and the second discharge electrode, the first discharge electrode serves as a scan electrode and a Y electrode, and the second discharge electrode serves as an address electrode and an X electrode in order to drive the plasma display panel.

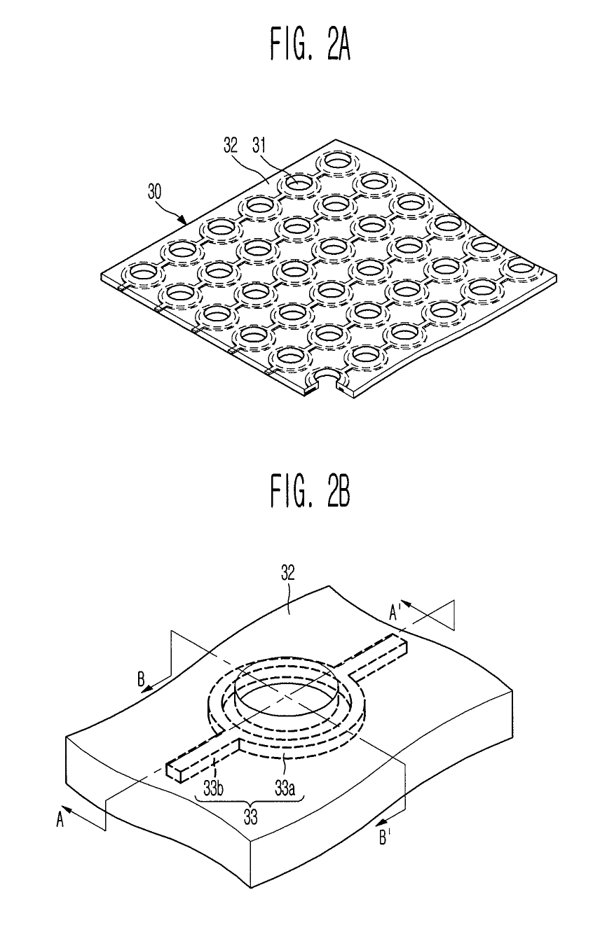

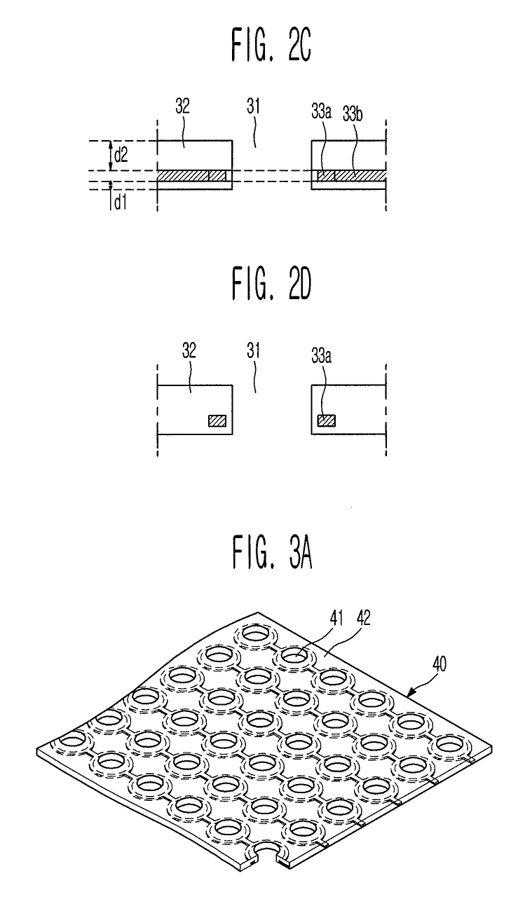

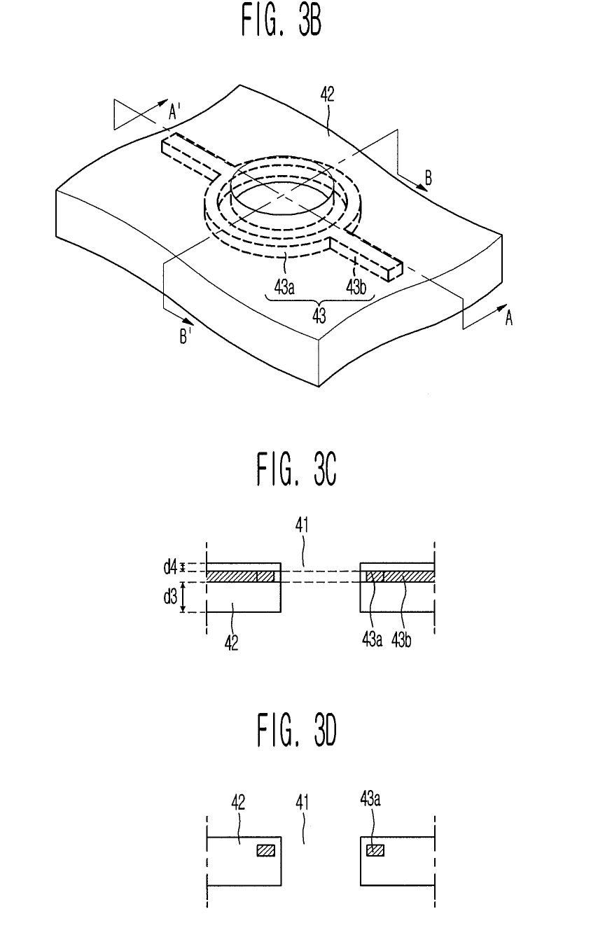

Referring to FIGS. 2A to 2D and FIGS. 3A to 3D, a configuration of the electrode sheet used in embodiments of the present invention will be described in more detail. FIG. 2A is a perspective view showing one embodiment of the first electrode sheet 30 as shown in FIG. 1, FIG. 2B is an enlarged view showing a circumferential region of a unit discharge hole in the first electrode sheet 30 as shown in FIG. 2A, FIG. 2C is a cross-sectional view taken along a line A-A′ as shown in FIG. 2B, and FIG. 2D is a cross-sectional view taken along a line B-B′ as shown in FIG. 2B. Also, FIG. 3A is a perspective view showing one embodiment of the second electrode sheet 40 as shown in FIG. 1, FIG. 3B is an enlarged view showing a circumferential region of a unit discharge hole in the second electrode sheet 40 as shown in FIG. 3A, FIG. 3C is a cross-sectional view taken along a line A-A′ as shown in FIG. 3B, and FIG. 3D is a cross-sectional view taken along a line B-B′ as shown in FIG. 3B. Also, FIG. 4 is a cross-sectional view showing a laminated structure of the first electrode sheet 30 and the second electrode sheet 40 as shown in FIGS. 2A to 2D and FIGS. 3A to 3D.

Referring to FIGS. 2A to 2D, FIGS. 3A to 3D, and FIG. 4, the first electrode sheet 30 includes a first dielectric layer 32 and a first discharge electrode 33. The first dielectric layer 32 is a layer for covering (or burying) a first discharge electrode 33, which includes a plurality of the above-mentioned first discharge holes 31. The first dielectric layer 32 is composed of a metal oxide (MxOy). In one embodiment, the metal oxide (MxOy) is selected from the group consisting of AlxOy, MgxOy, ZnxOy and FexOy (wherein x and y are each an integer).

The first discharge electrode 33 is an electrode for supplying a power from an external power source to the discharge cells, and is embedded (or buried) in (or covered by) the first dielectric layer 32 at around the first discharge hole 31. Here, the first discharge electrode 33 is not exposed to a surface of the first discharge hole 31. The first discharge electrode 33 is composed of a plurality of first discharge units 33a and a first connection unit 33b. Each of the first discharge units 33a has a closed curve, wherein the closed curve surrounds one of the above-mentioned first discharge holes 31. The first connection unit 33b is for connecting the first discharge units 33a, and it receives the power from the external power source and supplies the received power from the power source to the first discharge electrode 33. Here, the first discharge electrode 33 is composed of the same (or substantially the same) metal, for example, Al, Mg, Zn, and Fe, as the metal (M) of the metal oxide (MxOy), which is a material of the first dielectric layer 32, and a plurality of the first discharge electrodes 33 are extended in a first direction.

The second discharge electrode 43 is an electrode for reacting with the first discharge electrode 33 to cause a discharge, and both electrodes 43 and 33 play a complementary role with each other. That is, if the first discharge electrode 33 serves as a scan electrode during an address period and serves as a Y electrode during a sustain period in driving the electrode sheets 40 and 30, the second discharge electrode 43 serves as an address electrode during the address period and serves as an X electrode during the sustain period.

Also, the second electrode sheet 40 includes a second dielectric layer 42 and a second discharge electrode 43. The second dielectric layer 42 is a layer for covering (or burying) a second discharge electrode 43, and has a plurality of the above-mentioned second discharge holes 41. The second dielectric layer 42 is composed of a metal oxide (MxOy). In one embodiment, metal oxide (MxOy) is selected from the group consisting of AlxOy, MgxOy, ZnxOy and FexOy (wherein x and y are each an integer).

The second discharge electrode 43 is composed of a plurality of second discharge units 43a and a second connection unit 43b. Each of the second discharge units 43a has a closed curve, wherein the closed curve surrounds the above-mentioned second discharge holes 41. The second connection unit 43b is for connecting the second discharge units 43a, and receives a power from an external power source and supplies the received power for the external power source to the second discharge electrode 43.

Here, the second discharge electrode 43 is composed of the same (or substantially the same) metal as the metal (M) of the metal oxide (MxOy), which is a material of the second dielectric layer 42, and a plurality of the second discharge electrodes 43 are extended in a second direction different from the first direction of the first discharge electrode 33.

In addition, the first electrode sheet 30 includes a first surface in contact with the rear glass substrate 10 and a second surface in contact with the second electrode sheet. Here, a discharge unit 33a of the first discharge electrode 33 is embedded (or buried) by the first dielectric layer 32 at a point such that a distance (d1) between the discharge unit 33a of the first discharge electrode 33 and the first surface is smaller than a distance (d2) between the discharge unit 33a of the first discharge electrode 33 and the second surface.

Also, the second electrode sheet 40 also includes a first surface in contact with the first electrode sheet 30 and a second surface in contact with the front glass substrate 20. Here, a discharge unit 43a of the second discharge electrode 43 is embedded (or buried) by the second dielectric layer 42 at a point such that a distance (d3) between the discharge unit 43a of the second discharge electrode 43 and the first surface is larger than a distance (d4) between the discharge unit 43a of the second discharge electrode 43 and the second surface.

Here, a distance between the first discharge electrode 33 and the second discharge electrode 43 is extended to enhance a Vacuum Ultra Violet (VUV) emission by a long gap effect. In addition, a focusing effect may be improved with the increased volume of the internally formed plasma. Also, it is possible to reduce an undesired power consumption of the plasma display panel.

According to an experiment, if a discharge unit of the discharge electrode is extended from 50 μm to 100 μm, then an electric current is increased by a factor of two, but a luminance is increased by a factor of four, and therefore it is possible to obtain a synergic improvement by as much as a factor for two.

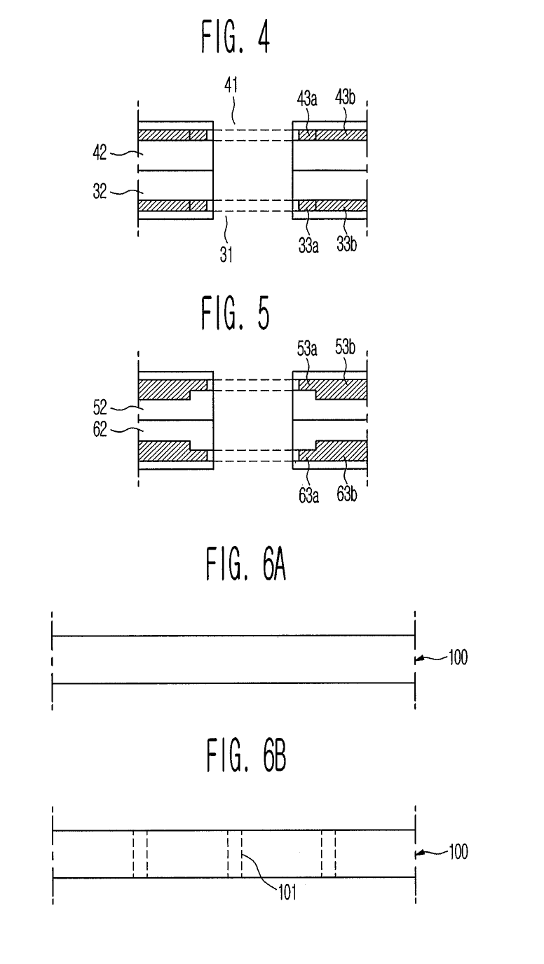

In addition, the above-mentioned electrode sheet may be manufactured so that a thickness of the connection unit is different from that of the discharge unit. FIG. 5 is a cross-sectional view showing a laminated structure of a first electrode sheet and a second electrode sheet according to another embodiment of the present invention. Referring to FIG. 5, in this embodiment, connection units 53b, 63b are formed with a thicker thickness than those of the discharge units 53a, 63a, respectively. In this configuration, a distance between the first discharge unit 53a and the second discharge unit 63a, which are actually discharged, is further extended, and therefore it is possible to anticipate a further corresponding beneficial effect, and a line resistance may also be reduced since it is possible to ensure a thickness of the connection unit.

Here, the electrode sheet including the discharge electrode and the dielectric is, in one embodiment, a one-piece sheet formed through an anodizing process as described in more detail below.

Hereinafter, a method for manufacturing an electrode sheet according to an embodiment of the present invention using a metal anodizing process will be described in more detail.

Also, hereinafter, the term “metal anodizing” refers to a method in which a thin oxide film is formed on a surface of a metal to protect the portion of the metal inside the oxide film. In one embodiment, the oxide film is utilized by a metal that can form an oxide film on its surface by itself due to its high reactivity to oxygen, such as aluminum (Al), titanium (Ti), and magnesium (Mg), and the metal anodizing method is utilized to artificially form an oxide film having a constant thickness by accelerating an oxidation reaction in the metal surface so that the metal can serve as an anode in a suitable solution (e.g., a solution of sulfuric acid, etc.).

Accordingly, if the metal having a certain (or predetermined) thickness is exposed to an anodizing solution with a certain (or predetermined) density for a certain (or predetermined) time period, the exposed region is oxidized to lose its metal properties, and therefore a surface of the metal becomes a dielectric material with a relatively low electrical conductivity, but the portion of the metal inside the oxide film is still not oxidized and maintains its metal properties.

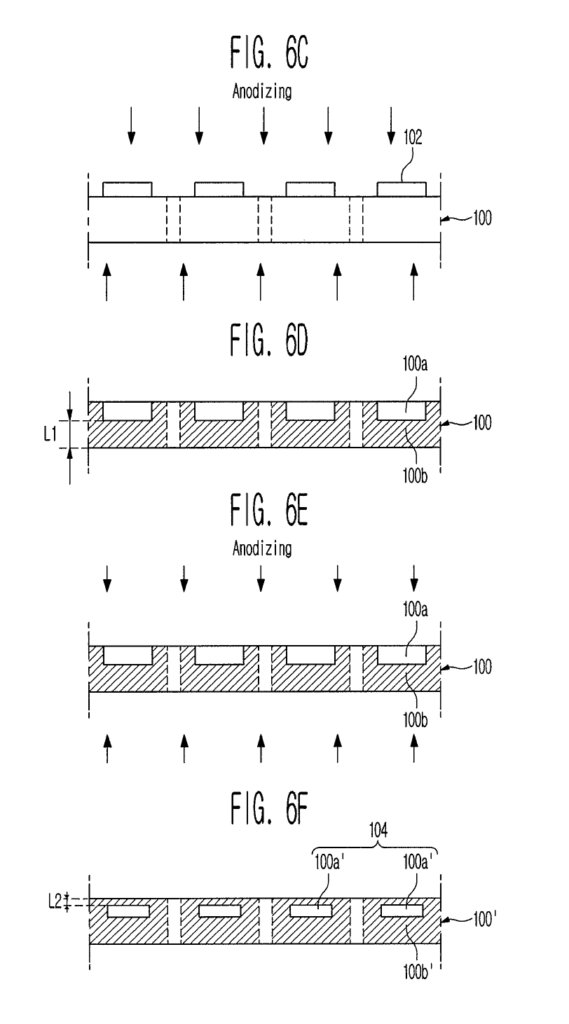

Accordingly, in this embodiment, such a metal anodizing process is used to manufacture an electrode sheet. FIGS. 6A to 6F are perspective views illustrating such a manufacturing process.

FIG. 6A illustrates a step of preparing a metal sheet 100. In one embodiment, the used metal sheet 100 has a thickness ranging from about 10 μm to about 200 μm (or from 10 μm to 200 μm).)

FIG. 6B illustrates a step of forming one or more discharge holes 101 on the metal sheet 100. Here, a discharge hole 101 having a certain (or predetermined) diameter is formed using an etching or drilling process. In one embodiment, the discharge hole has a diameter ranging from about 50 μm to about 300 μm (or from 50 μm to 300 μm).

FIG. 6C illustrates a step of anodizing a region where a protective film is not attached to a first depth (L1) by attaching a protective film 102 such as Dry Film Resistor (DFR) to a region that will be used as a discharge electrode so as to prevent the region from being anodized. Here, the first depth (L1) is measured from a surface of the metal sheet 100 facing oppositely a surface of the metal sheet 100 wherein the protective film 102 is attached.

FIG. 6D illustrates a step of removing the protective film 102 from the metal sheet 100 which is divided into a region 100b that is anodized to become a dielectric, and a region 100a that is not anodized and remain as a metal.

Subsequently, FIG. 6E illustrates a step of anodizing the entire metal sheet 100 without the protective film 102 to form a discharge electrode 104. Here, by controlling the anodizing of the region to which the protective film 102 was attached to a second depth (L2), the inside of the discharge electrode 104 is not anodized. Here, the second depth (L2) is measured from the surface of the metal sheet 100 where the protective film 102 was attached, and the discharge electrode 104 is formed in such a manner that the second depth (L2) can be different from the first depth (L1).

FIG. 6F illustrates that the anodized region 100b′ is composed of metal oxides to form a dielectric layer, and non-anodized region 100a′ remains as a metal, and therefore an electrode sheet 100′ is manufactured where the discharge electrode 104 is formed at different distances to the surfaces of the dielectric. (FIG. 6f)

Here, the distance between the surfaces of the electrode sheet in the discharge electrode and the thickness of the discharge unit and the connection unit in the discharge electrode may be adjusted by employing an additional protective film, or by controlling an anodizing time, etc., a configuration of which may be suitably varied.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof. For example, the discharge cell of the plasma display panel according to an embodiment of the present invention may further include a protective layer composed of MgO, etc.

What is claimed is:

1. An electrode sheet for a plasma display panel, comprising:
a dielectric layer having a first surface and a second surface and comprising a plurality of discharge holes defined by side walls of discharge spaces, the dielectric layer being composed of a metal oxide; and
a discharge electrode comprising a plurality of discharge units around circumferences of the discharge holes and a connection unit for connecting the discharge units to each other, the discharge electrode being embedded inside the dielectric layer, the discharge electrode being composed of a metal of the metal oxide,
wherein the discharge units of the discharge electrode are embedded inside the dielectric layer so that a distance between the discharge units and the first surface is different from a distance between the discharge units and the second surface.

2. The electrode sheet for a plasma display panel according to claim 1, wherein the metal is selected from the group consisting of Al, Mg, Zn and Fe.

3. The electrode sheet for a plasma display panel according to claim 1, wherein the connection unit and the discharge units of the discharge electrode have substantially identical thicknesses.

4. The electrode sheet for a plasma display panel according to claim 1, wherein the connection unit of the discharge electrode is thicker than that of the discharge units.

5. The electrode sheet for a plasma display panel according to claim 1, wherein each of the discharge holes has a circular shape.

6. The electrode sheet for a plasma display panel according to claim 1, wherein each of the discharge units of the discharge electrode has a closed curve to respectively surround each of the discharge holes.

7. A plasma display panel, comprising:
a first glass substrate;
a second glass substrate facing the first glass substrate and arranged with the first glass substrate with a gap therebetween;
a first dielectric layer arranged between the first glass substrate and the second glass substrate and comprising a plurality of first discharge holes defined by side walls of discharge spaces, the first dielectric layer being composed of a metal oxide;
a first electrode sheet embedded inside the first dielectric layer and comprising a plurality of first discharge units around circumferences of the first discharge holes and a first connection unit for connecting the first discharge units to each other, the first electrode sheet comprising a first discharge electrode composed of a metal of the metal oxide;
a second dielectric layer arranged between the first electrode sheet and the second glass substrate and comprising a plurality of second discharge holes arranged to correspond to the first discharge holes and defined by the side walls of the discharge spaces; and
a second electrode sheet embedded inside the second dielectric layer and comprising a plurality of second discharge units around circumferences of the second discharge holes and a second connection unit for connecting the second discharge units to each other, the second electrode sheet comprising a second discharge electrode composed of a metal of the metal oxide,
wherein the first discharge units of the first discharge electrode are embedded inside the first dielectric layer so that a distance between the first discharge units and a surface where the first dielectric layer is in contact with the first glass substrate is smaller than a distance between the first discharge units and a surface where the first dielectric layer is in contact with the second dielectric layer, and
wherein the second discharge units of the second discharge electrode are embedded inside the second dielectric layer so that a distance between the second discharge units and a surface where the second dielectric layer is in contact with the first dielectric layer is larger than a distance between the second discharge units and a surface where the second dielectric layer is in contact with the second glass substrate.

8. The plasma display panel according to claim 7, wherein the first connection unit of the first discharge electrode is thicker than the first discharge units, and
the second connection unit of the second discharge electrode is thicker than the second discharge units.

9. The plasma display panel according to claim 7, wherein each of the first discharge holes and the second discharge holes has a circular shape.

10. The plasma display panel according to claim 7, wherein each of the first discharge holes and the second discharge holes has a diameter ranging from about 50 μm to about 300 μm.

11. The plasma display panel according to claim 7, wherein a distance between the first discharge electrode and the second discharge electrode ranges from about 50 μm to about 300 μm.

12. The plasma display panel according to claim 7, wherein the metal oxide of the first dielectric layer and the metal oxide of the second dielectric layer are selected from the group consisting of AlxOy, MgxOy, ZnxOy and FexOy, and wherein x and y are each an integer.

13. The plasma display panel according to claim 7, wherein the metal of the first discharge electrode and the metal of the second discharge electrode are selected from the group consisting of Al, Mg, Zn and Fe.

14. The plasma display panel according to claim 7, wherein each of the first discharge units of the first discharge electrode has a closed curve to respectively surround each of the first discharge holes,
wherein each of the second discharge units of the second discharge electrode has a closed curve to respectively surround each of the second discharge holes.

15. A method for manufacturing an electrode sheet for a plasma display panel in which a discharge electrode is embedded, the discharge electrode including a plurality of discharge units around circumferences of a plurality of discharge holes and a connection unit for connecting the discharge units to each other, and the discharge units are formed so that a distance from the discharge units to one surface of the dielectric layer is different from a distance from the discharge unit to another surface of the dielectric layer, the method comprising:
providing a metal sheet;
forming a plurality of discharge holes on the metal sheet;
attaching a first protective film for forming a pattern of a discharge electrode to a first surface of the metal sheet;
anodizing a region of the metal sheet where the first protective film is not attached to a first depth measured from a second surface of the metal sheet;
detaching the first protective film; and
anodizing the metal sheet to a second depth measure from the first surface of the metal sheet to form the discharge electrode, wherein the second depth is different from the first depth.

16. The method for manufacturing an electrode sheet for a plasma display panel according to claim 15, wherein the second depth is less than the first depth.

17. The method for manufacturing an electrode sheet for a plasma display panel according to claim 15, wherein the forming of the discharge holes utilizes an etching or drill punching process.

18. The method for manufacturing an electrode sheet for a plasma display panel according to claim 15, further comprising:
attaching, anodizing and detaching a second protective film for protecting the discharge electrode after the detachment of the first protective film and before the formation of the discharge electrode.

19. The method for manufacturing an electrode sheet for a plasma display panel according to claim 15, wherein the connection unit of the discharge electrode is formed to be thicker than that of the discharge units.

20. The method for manufacturing an electrode sheet for a plasma display panel according to claim 15, wherein the connection unit and the discharge units of the discharge electrode are formed to have substantially identical thicknesses.
